(19) United States
(12) Patent Application Publication
(10) Pub. No.: US 2010/0209558 A1
(43) Pub. Date: Aug. 19, 2010

(54) DIETARY INGREDIENT WITH ENHANCED BIOAVAILABILITY

(75) Inventor: Guru Ramanathan, Pittsburgh, PA (US)

Correspondence Address: MCGUIREWOODS, LLP, 1750 TYSONS BLVD, SUITE 1800, MCLEAN, VA, 22102, US

(73) Assignee: General Nutrition Corporation, Pittsburgh, PA (US)

(21) Appl. No.: 12/707,280

(22) Filed: Feb. 17, 2010

Related U.S. Application Data
(60) Provisional application No. 61/153,862, filed on Feb. 19, 2009.

(51) Int. Cl. A23L 1/30; A23L 1/302; A23L 1/304; A23L 1/305

(52) U.S. Cl. 426/72; 426/648

(57) ABSTRACT

The invention is directed to an improved composition and process for enhanced bioavailability. The composition includes a dietary supplement that is micronized and combined with polyethylene glycol. The process of increasing the bioavailability of a dietary ingredient includes ingesting a dietary supplement that is micronized and combined with polyethylene glycol.

### CROSS REFERENCE TO PRIOR APPLICATIONS

This application claims priority and the benefit thereof form U.S. Provisional patent application No. 61/153,862, filed on Feb. 19, 2009, which hereby incorporated by reference for all purposes as if fully set forth herein.

### BACKGROUND OF THE INVENTION

1. Field of the Invention

The invention is directed to a dietary ingredient and/or supplement, including but not limited to a vitamin, mineral, herbal, protein, amino acid, or fatty acid. The dietary ingredient may be micronized and may be combined with a bioavailability composition such as polyethylene glycol (PEG). The dietary ingredient may also be enteric coated.

2. Related Art

Many dietary ingredients or supplements are intended to help the user achieve optimum health. For example, many people consume multivitamins to ensure that they are getting the recommended amounts of important vitamins and nutrients. While few people in developed countries suffer from diseases that are caused by insufficient vitamins, such as scurvy, or from acute malnutrition, many vitamins and nutrients help to provide a strong immune system, proper circulation, mental alertness, and other benefits that contribute to a person's overall sense of health and wellness.

Moreover, many people take supplements of very specific compounds to achieve results that are more narrowly focused than simply promoting overall health. Body builders and athletes frequently take supplements, such as arginine or whey protein, to enhance their cardiovascular endurance or their ability to increase muscle mass. In addition to providing similar benefits for athletes, creatine may improve mental acuity in certain individuals, including the elderly.

One potential drawback to such dietary ingredients or supplements is that only a small fraction of what is consumed reaches the cells in the body where it can achieve a beneficial effect. Creatine, for example, breaks down rapidly in the stomach, and the creatine that is absorbed into the bloodstream is efficiently cleared by the kidneys. Thus, athletes and other creatine users must consume very large amounts to achieve the desired result, but this is not without its own drawbacks, including the unappetizing prospect of consuming larger amounts of powder each day. In addition, these large amounts of creatine are very costly, have increased storage costs, take up a larger storage space, have increased shipping costs, and the like.

One solution to this problem has been to conjugate polyethylene glycol (PEG) to the dietary ingredient. PEG greatly increases the efficacy of its carrier by lengthening the amount of time that the dietary ingredient remains in the blood. Circulating time is improved because PEG decreases the efficiency of renal clearance, protects against protease digestion, reduces immunogenicity and the like. PEG achieves these effects with a minimal loss of biological activity, making it an ideal conjugate for enhancing bioavailability.

Nonetheless, large doses of dietary supplements may still be required, even when used together with PEG. These doses, however reduced, may continue to have high costs and so on without associated benefits. Accordingly, there is a need for a dietary supplement that has enhanced bioavailability.

### SUMMARY OF THE INVENTION

The invention meets the foregoing need and provides a dietary ingredient that has been micronized and combined with polyethylene glycol, which results in a significant and unexpectedly large increase in bioavailability of the dietary ingredient and other advantages apparent from the discussion herein.

In one aspect of the invention, a composition includes a dietary supplement that is micronized and combined with polyethylene glycol.

According to another aspect of the invention, a process of increasing the bioavailability of a dietary ingredient includes ingesting a dietary supplement that is micronized and combined with polyethylene glycol.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a comparison of the blood concentration of regular leucine and bioenhanced leucine, produced according to the present disclosure, over time;

FIG. 2 is a graph of the rate of accumulation of leucine; and

FIG. 3 shows the impact of bioenhanced arginine on physical performance.

### DETAILED DESCRIPTION OF THE INVENTION

The embodiments of the present disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the present disclosure may be practiced and to further enable those of skill in the art to practice the embodiments of the invention. Accordingly, the examples and embodiments herein should not be construed as limiting the scope of the present disclosure, which is defined solely by the appended claims and applicable law. Moreover, it is noted that like reference numerals represent similar parts throughout the several views of the drawings.

According to one aspect of the disclosure, a dietary ingredient may be provided. The dietary ingredient may be, for example, a vitamin, mineral, herbal, protein, amino acid, or fatty acid. Specific, non-limiting examples include whey protein, leucine, arginine, creatine, selenium, zinc, magnesium, chromium, niacin, folic acid, biotin, ginkgo biloba extract, green tea extract, grape seed extract, digestive enzymes, choline, inositol, lycopene, vitamin A, vitamin B₆, vitamin B₁₂, vitamin C, vitamin E, ribose, carnitine, CoQ10, glucosamine, and chondroitin. It is also contemplated and within the scope of the invention that the dietary ingredient may be, for example, a combination of one or more of a vitamin, a mineral, an herbal, a protein, an amino acid, and/or a fatty acid. By way of example only, the dietary ingredient may be a mixture of leucine, whey protein, and digestive enzymes. Additional, non-limiting examples include a mixture of creatine and grape seed extract and a mixture of arginine and grape seed extract.

The dietary ingredient may be micronized. The micronization process generally produces particles that are, on average, only a few micrometers in diameter. For example, the particles of the dietary ingredient may have a maximum diameter of 10 μm; the particles of the dietary ingredient may have an average diameter of 2 μm; the particles of the dietary ingredient may have a maximum diameter of 2 μm, or any other particle size as required by the specific application of the principles of the present disclosure. It is contemplated and within the scope of the present disclosure that the average particle size may be less than 1 μm and may be as small as 100 nm or smaller, depending on the requirements of the specific application and the ability of available micronization technology to reduce particle size.

Micronization may be accomplished by any means known in the art, whether known at the time of invention or developed subsequent to the invention. It is contemplated that the dietary ingredient may be micronized by techniques that rely on friction to reduce particle size. For example, a milling process may be used to reduce particle size. In a milling process, the dietary ingredient is placed inside a cylinder along with a number of spheres. As the cylinder is turned, the spheres crush the dietary ingredient into particles of smaller size. The milling process may also use a jet mill. Alternatively, a grinding process, which reduces particle size by trapping particles between two grinding units that are rubbing together, may be used to micronize the dietary ingredient. Processes that use a supercritical fluid to micronize particles are also contemplated and within the scope of the present disclosure. These processes include rapid expansion of supercritical solutions (RESS), supercritical anti-solvent (SAS), and particles from gas-saturated solutions (PGSS). Finally, novel micronization processes that may be developed in the future are also contemplated and within the scope of the present disclosure.

The dietary ingredient may also be combined with polyethylene glycol (PEG) either in a simple physical dispersion or by a covalent link or conjugation to one or more molecules of polyethylene glycol (PEG), a process known as PEGylation. The molecular weight of PEG used in the invention may range, for example, from roughly 140 daltons to approximately 20,000 daltons. Monomethoxy-polyethylene glycol (mPEG), a triethylene glycol, is specifically contemplated for use with the invention. PEGylation of the dietary ingredient may be effected by any means known to one skilled in the art, using molecular weights of PEG and functional groups that are appropriate to the particular dietary ingredient of a specific embodiment. Other PEGylation equivalents are also contemplated by the present disclosure and are thus within its spirit and scope.

The most preferred form of the PEG component is PEG 3350, which contains PEG with an average molecular weight between 3015 and 3685. PEG 3350 is available under the trade name Carbowax™ PEG 3350 as a hard, opaque white solid. Other preferred forms of PEG are also opaque white solids. Other preferred forms are PEG 1450, which has an average molecular weight of 1305 to 1595; PEG 4000, which has an average molecular weight from 3600 to 4400; PEG 4600, which has an average molecular weight from 4400 to 4800; PEG 8000, which has an average molecular weight from 7000 to 9000; and PEG 6000, which has an average molecular weight of 6000 to 7500.

For embodiments of the present disclosure that include creatine, the most preferred form of creatine is the creatine hydrochloride (creatine.HCl) salt and the most preferred form of PEG is PEG 3350. Embodiments that include creatine may include forms of creatine other than creatine hydrochloride. For embodiments that contain creatine, the most preferred form is a solid dispersion of creatine hydrochloride in PEG 3350. Such embodiments may be coated with an enteric coating. Additional preferred forms of creatine include any creatine salt that is more soluble in room-temperature aqueous solutions than creatine monohydrate (creatine.H₂O).

While the present disclosure has been described in terms of exemplary embodiments, those skilled in the art will recognize that the present disclosure can be practiced with modifications in the spirit and scope of the appended claims. These examples given above are merely illustrative and are not meant to be an exhaustive list of all possible designs, embodiments, applications or modifications of the invention.

### EXAMPLES

### Specific Example 1

Whey protein, which is a byproduct of cheese manufacturing, and leucine were milled to produce micronized particles. This was then combined with digestive enzymes and PEG 3350 in a physical dispersion. A serving of the dietary supplement included 20 g whey protein, 7 g leucine, 1 g PEG 3350, and 200 mg digestive enzymes.

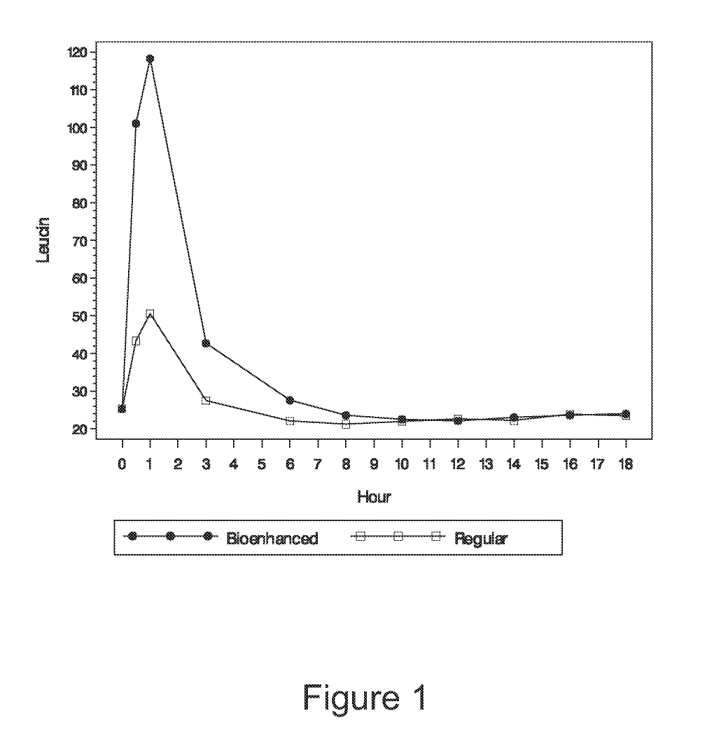

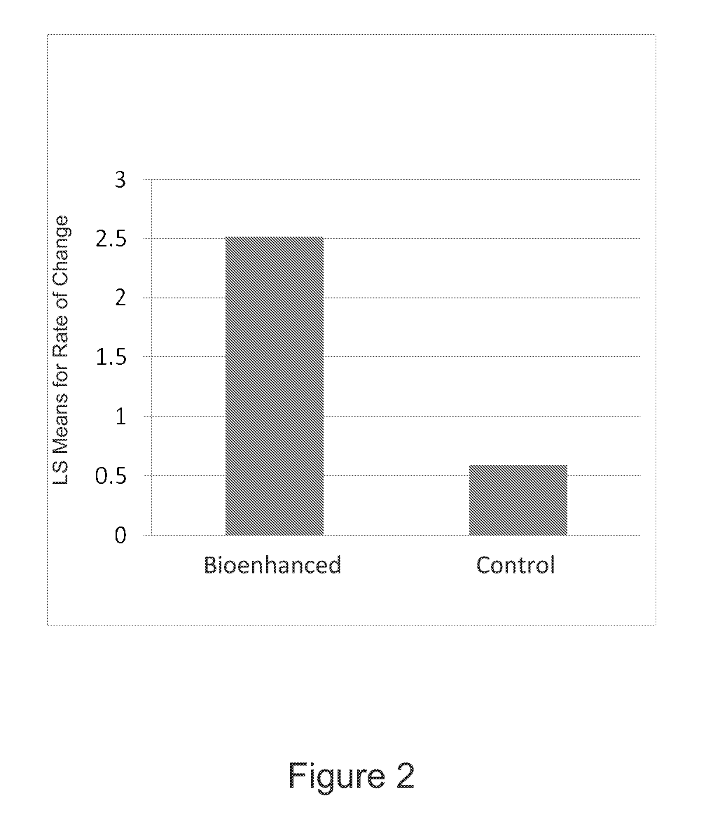

After 10 hours of fasting, test subjects ingested either the formulation above or a control formulation of 20 g non-micronized whey concentrate. Blood samples were collected at regular intervals over the next 18 hours to measure serum amino acid concentrations. Subjects who took the investigative formulation showed much higher serum amino acid concentrations than did the subjects who consumed the control supplement. In many cases, the peak amino acid concentrations were more than double those with the control, thereby demonstrating that the micronized and PEGylated ingredient provides unexpected results in comparison to the current state of the art. FIG. 1 shows this increase in concentration of the bioenhanced leucine compared to regular leucine. The experimental formulation also resulted in a much faster rate of accumulation of leucine and other amino acid concentrations, as shown in FIG. 2.

### Specific Example 2

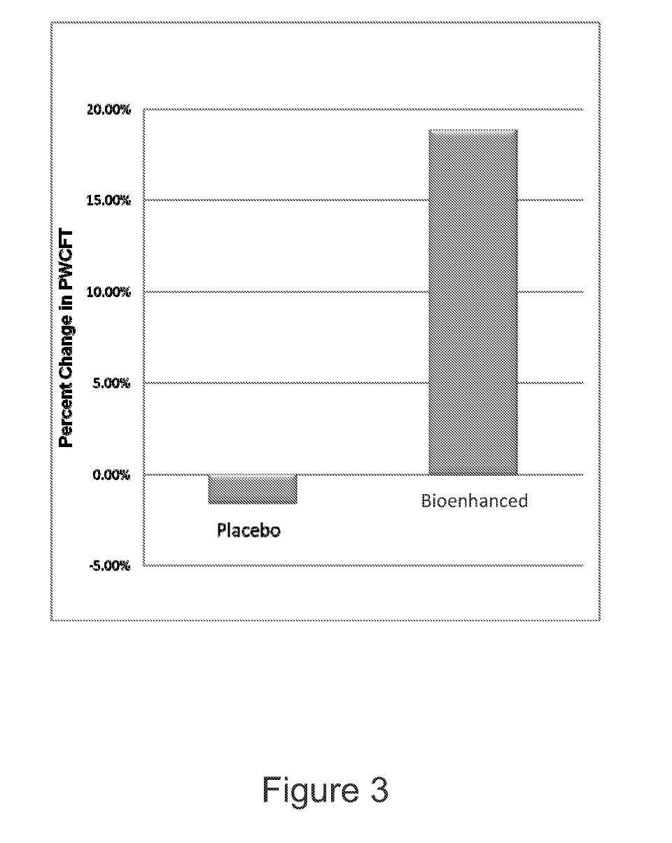

The amino acid arginine was micronized, combined with a grape seed extract, and physically dispersed with PEG 3350. The final mixture was compressed into a tablet form and enteric coated. Test subjects received either 3 g arginine combined with 300 mg PEG and 300 mg grape seed extract; 1.5 g arginine combined with 150 mg PEG and 300 mg grape seed extract; or placebo. Endurance of the test subjects, as measured by physical working capacity at the fatigue threshold (PWC_{FT}), ventilatory threshold (VT), and maximal oxygen consumption rate (VO₂max), was recorded. Subjects took the supplement for 28 days, and endurance was measured again. As shown in FIG. 3, subjects receiving the test formulation showed a dramatic improvement of 20% in physical working capacity at fatigue threshold over subjects receiving placebo.

What is claimed is:

1. A composition comprising:
a micronized dietary supplement; and
polyethylene glycol,
wherein the micronized dietary supplement is combined with the polyethylene glycol to produce a substantially homogenized mixture.

2. The composition of claim 1, wherein the dietary supplement is micronized by at least one of milling and grinding.

3. The composition of claim 1, wherein the dietary supplement is at least one of a vitamin, a mineral, an herbal, a protein, an amino acid, an amino sugar, and a fatty acid.

4. The composition of claim 1, further comprising an enteric coating.

5. The composition of claim 1, wherein the composition is in a powder form.

6. The composition of claim 1, wherein the dietary supplement is combined with polyethylene glycol in a physical dispersion.

7. The composition of claim 1, wherein the polyethylene glycol has a molecular weight between approximately 140 daltons to approximately 20,000 daltons.

8. The composition of claim 1, wherein the micronized dietary supplement comprises particles with a maximum diameter of 10 μm.

9. The composition of claim 1, wherein the micronized dietary supplement comprises particles with a maximum diameter of 2 μm.

10. The composition of claim 1, wherein the micronized dietary supplement comprises particles with an average diameter of 2 μm.

11. The composition of claim 1, wherein the micronized dietary supplement comprises particles with an average diameter less than 1 μm.

12. A process for increasing the bioavailability of a dietary ingredient, the process comprising
micronizing a dietary supplement; and
combining the micronized dietary supplement with polyethylene glycol, resulting in a substantially homogenized mixture.

13. The process of claim 12, wherein the dietary supplement is micronized by at least one of milling and grinding.

14. The process of claim 12, wherein the dietary supplement is at least one of a vitamin, a mineral, an herbal, a protein, an amino acid, an amino sugar, and a fatty acid.

15. The process of claim 12, further comprising an enteric coating.

16. The process of claim 12, wherein the composition is in a powder form.

17. The process of claim 12, wherein the dietary supplement is combined with polyethylene glycol in a physical dispersion.

18. The process of claim 12, wherein the micronized dietary supplement comprises particles with a maximum diameter of 10 μm.

19. The process of claim 12, wherein the micronized dietary supplement comprises particles with a maximum diameter of 2 μm.

20. The process of claim 12, wherein the micronized dietary supplement comprises particles with an average diameter of 2 μm.

21. The process of claim 12, wherein the micronized dietary supplement comprises particles with an average diameter less than 1 μm.
